(19) United States
(12) Patent Application Publication
(10) Pub. No.: US 2005/0278617 A1
(43) Pub. Date: Dec. 15, 2005

(54) Methods and systems for dynamically assembling web pages

(76) Inventors: Lawrence Robert Martell, Huntington, NY (US); Krzysztof Gasiorowski, E. Northport, NY (US)

Correspondence Address: KENYON & KENYON, 1500 K STREET NW, SUITE 700, WASHINGTON, DC, 20005, US

(21) Appl. No.: 10/866,670

(22) Filed: Jun. 15, 2004

(51) Int. Cl. G06F 17/00

(52) U.S. Cl. 715/513; 715/744; 709/203

(57) ABSTRACT

Systems and methods are used to dynamically assemble a web page at a web server. A plurality of content elements is prestored on the web server by associating each of the content elements with a unique file name. When a web page request is received at the web server, a content element request is generated from the web page request. The content element request is personalized. It is determined whether the personalized content element request corresponds to one of the plurality of content elements prestored at the web server. The corresponding content element is retrieved using the unique file name and the web page is dynamically assembled from the corresponding content element.

### TECHNICAL FIELD

The present invention relates to methods and systems for dynamically assembling a web page. In particular, the present invention relates methods and systems for dynamically assembling such a web page at a web server.

### BACKGROUND OF THE INVENTION

Vast increases in commerce on the Internet have occurred in recent years. These increases have generated large increases in traffic on the Internet. Many web sites have difficulty keeping up with the increased traffic with current technology. Several traffic related issues may arise, such as increasing web site outages, increasing costs and need for new hardware or software, escalating need for multiple software applications, decreasing web site speed, and exponential growth of messaging between system components.

The web sites may have to deliver web pages to thousands of customers. The web pages are often dynamic, so that tailored or personalized information may be delivered to each customer. The adding of complex personalization or constantly changing content on such pages, while maintaining high levels of system integrity and decreasing system complexity is a challenge.

Many web sites utilize web servers and application servers to generate such web pages. For example, a personalized page can be designed using one of many dynamic languages, such as JSP (Java), ASP, JHTML, or others. A request for a page such as “myhome.jsp” may be sent to a web server by a user browser requesting the page. The page is typically examined by a web server and the file extension is recognized (in this example .jsp). The web server routes to the appropriately configured application server. The application server will either compile the JSP page for the first time and execute it or execute the page from its compiled folders. The result of the “myhome.jsp” from the application server is sent to the web server and then passed on to the user/client's browser. Although such systems are very functional, they are extremely costly in terms of system resources, and relatively slow. As traffic on such a system increases, delays can increase to the point where customers may be lost. This may force service providers to provision costly additional hardware and software.

To try and solve some of these problems, one approach has been to cache personalized pages at the application server, with one cached page for each personalized user. This allows the application server to prestore content that changes quickly, but requires the application server to store an enormous amount of data. For example, if the web server is serving one million distinct users, the application server would have to cache one million separate pages. This approach has not proven viable due to the scalability issues in ail tiers involved in processing the request and also the inherent resource limitations at the application servers.

All of these approaches require requests for a web page to be made through the web server to the application server to be personalized and fresh. The application server is used to apply the information that characterizes the user in the form of the HTTP headers to send the content back to the web server.

### SUMMARY OF THE INVENTION

Systems and methods are used to dynamically assemble a web page at a web server. A plurality of content elements is prestored on the web server by associating each of the content elements with a unique file name. When a web page request is received at the web server, a content element request is generated from the web page request. The content element request is personalized. It is determined whether the personalized content element request corresponds to one of the plurality of content elements prestored at the web server. The corresponding content element is retrieved using the unique file name and the web page is dynamically assembled from the corresponding content element.

### BRIEF DESCRIPTION OF THE DRAWINGS

FIG. 1 is a block diagram in accordance with an embodiment of the present invention.

FIG. 2 is a block diagram in accordance with an embodiment of the present invention.

FIG. 3 illustrates a system in conjunction with embodiments of the present invention.

FIG. 4 illustrates a flowchart in accordance with embodiments of the present invention.

FIG. 5 illustrates a flowchart in accordance with embodiments of the present invention.

### DETAILED DESCRIPTION

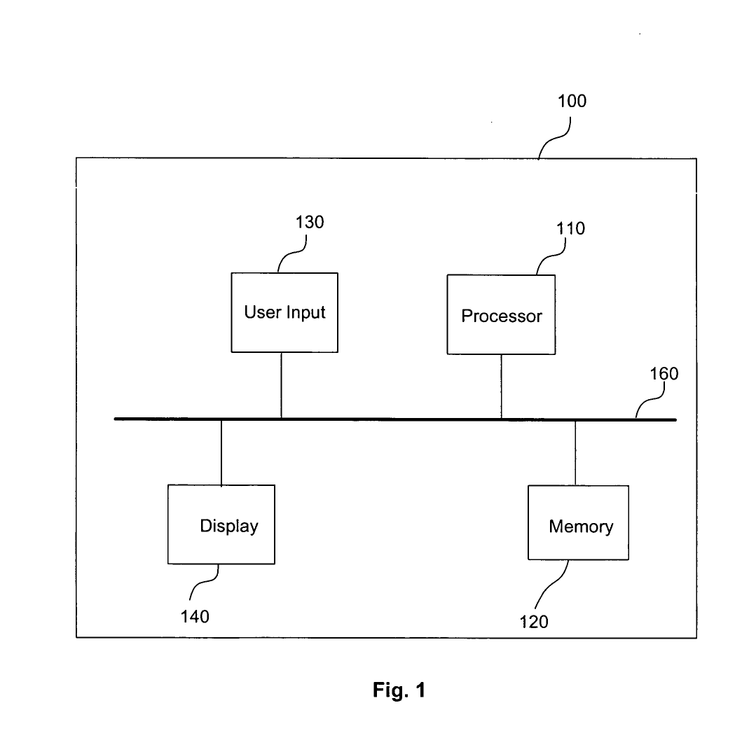

FIG. 1 depicts a block diagram of an embodiment of the present invention. Computing device 100 is suitable for use with the present invention. The computing device 100 may include a processor 110, a memory 120, a user input 130 and a display 140. The memory 120 may contain software to be run in conjunction with processor 110, and may cause images to be displayed on display 140. The software may be specifically designed to cause computing device 100 to implement the present invention. Computing device 100 may be one of various types of computing devices, such as a workstation, a personal computer, a server, a headend in a cable system, or any other type of computing device.

The processor 110 may be a general-purpose microprocessor, such as a Pentium series microprocessor manufactured by the Intel Corporation of Santa Clara, Calif. In another embodiment, the processor 110 can be an Application Specific Integrated Circuit (ASIC), which has been designed to implement in its hardware and/or firmware at least a part of a method in accordance with embodiments of the present invention.

Memory 120 can be any device capable of storing analog or digital information, such as a hard disk, Random Access Memory (RAM), Read Only Memory (ROM), flash memory, a compact disk, a magnetic tape, a floppy disk, and any combination thereof, for example.

User input 130 can be any type of input device, such as a keyboard, keypad, pointing device, microphone, mouse, wired or wireless remote control, touch pad, touch screen, a port(s) to attach other input devices, voice recognition software, etc. Any type of input device will function in accordance with embodiments of the present invention.

The display 140 can be any type of display or screen that is capable of displaying images. For example, the display may be a CRT or LCD monitor, a heads-up display, a television, etc. The display 140 may be structurally included as part of the electronic device, or may be physically separated from but connected with the other components of device 100, such as a monitor in a desktop computer.

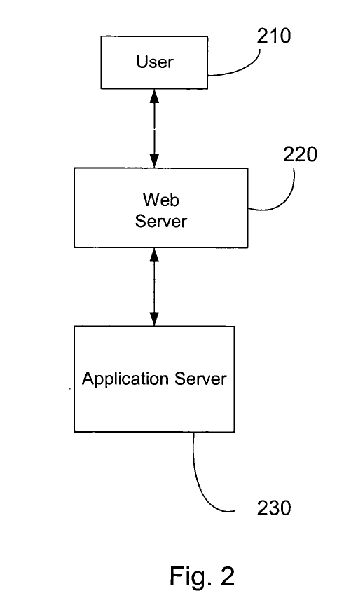

FIG. 2 depicts a block diagram of an embodiment of the present invention. The system includes a web server 220. The web server 220 may be a computer such as the computer described in conjunction with FIG. 1, that includes a processor, a memory, and software programmed to carry out the functionality of the present invention. The web server 220 may also be a standard web server such as a web server used by an Internet Service Provider (ISP) or other content entity, such as a company that hosts content. The web server 220 may deliver web pages to a user 210 over the Internet by a connection such as a dial-up connection, a cable modem or cable television connection, wireless connection, or any other sort of connection. This embodiment could also include other devices, such as proxy servers, caching servers or load balancers, between user 210 and web server 220.

The web server 220 may be connected to an application server 230. The web server 220 may receive a web page request from the user 210, typically from a browser on a user's computer. The web page request typically will be used to generate a request for at least one content element, and may typically be accompanied by one or more cookies, IP addresses, or other HTTP header information. The web page may be dynamically assembled specifically for that user. As used herein, the term “dynamically assembled web page” is defined as a web page that includes one or more personalized content elements. A “personalized content element” is defined as a content element that has been prestored in a web server file system and which has been assigned a unique file name that can be associated with cookie values, IP addresses and/or other HTTP header information.

A “personalized content element request” is defined as a unique signature URL that can be derived based on syntax included in a web page, cookie values, IP addresses and/or other HTTP header information. A unique signature URL is assigned to each of these personalized content element requests, even though those requests can be subsections of the complete web page request. The user may not have access to the signature URL but the web server does.

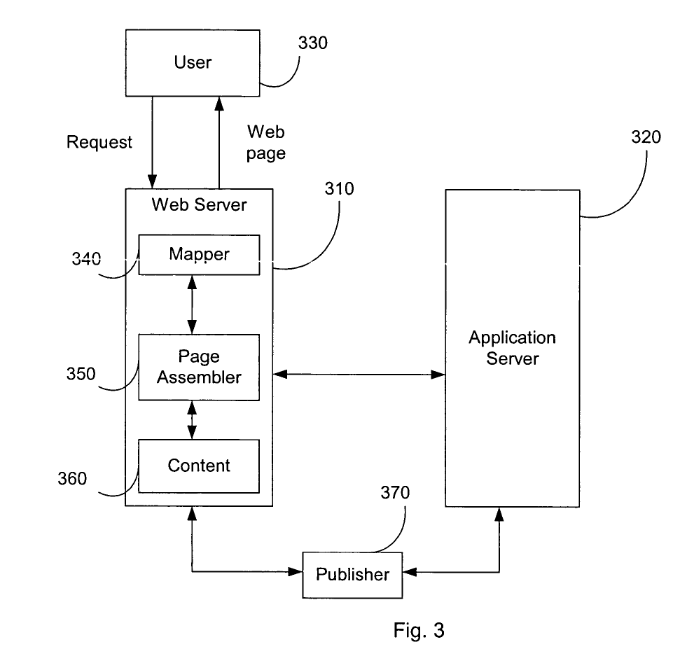

FIG. 3 illustrates a system in conjunction with embodiments of the present invention. Web server 310 includes three elements, a mapper 340, a page assembler 350, and stored content elements 360. When a request for a web page is received from a user 330 at the web server 310, the web page request may result in generating one or more content element requests. The web server 310 invokes the mapper 340 to personalize the one or more content element requests. A content element request is personalized when the mapper 340 combines the original content element request and the values that may accompany the original content element request (cookies, IP addresses, HTTP header information) based on the logic specified in the mapping file to create a signature URL. The resulting signature URL is then used by the web server 310 to uniquely locate a personalized content element with a corresponding filename on the web server file system. If the corresponding personalized content element is located on the web server file system, it is retrieved. The page assembler 350 then dynamically assembles the page, which may be returned to the user 330.

The assembled page may contain specific syntax that may indicate that the process described in step 21 should repeat recursively until no further reference is found.

The personalized content elements are prestored in the web server file system using a file name, which may be a unique signature URL. The file name may contain a standard name and extension (myhome.jsp) but also may contain unique elements that make it a signature. Items may be added such as cookie name value (weather=Seattle) or IP address, browser type or other HTTP headers. It is this unique signature URL that the mapper 340 and the web server 310 may use to identify and locate the specific personalized content element requested by the user. The desired content elements are retrieved, and then are assembled by page assembler 350. If the request cannot be mapped, no action is taken, the mapper actions are terminated, and the web server 310 takes over the evaluation of the request, which may involve passing control to the application server 320.

Each line in the mapping file may follow a specific syntax. For example, if the signature URL for a personalized content element or full page element is http://www.site.com/page and the corresponding application server resource designated as the content supplier can be accessed at /www.site.com/pages/page.jsp the system would find a corresponding syntax line in the mapping file. For example, a mapping file line could read:
Mapping file line: {cache|parse:/www.site.com/pages/page.jsp?{cookie:weather}}
   It is that syntax that will determine what personalized information will be applied and in what manner.

The mapper 340 reads this syntax line in the mapping file and is told to look for the file on the web server that has a name uniquely associated with specific cookie name “weather” with the specific weather value sent by the user in their page request. The mapper 340 then looks on the web server file system for a file with the corresponding signature: www.site.com/page?cookie:weather=<cookie_value>

The syntax may also further indicate that the line may cover more than one value expressed conditionally. Lines in the mapping file are evaluated until the expression is satisfied. For example, a mapping file line could read:
Mapping file line 1: {cache|parse:/www.site.com/pages/page.jsp?{cookie:weather=A*}}
Mapping file line 2: {cache|parse:/www.site.com/pages/page.jsp?{cookie:weather=*}}
   All requests that are accompanied by a cookie with value starting with letter “A” will be mapped to a personalized content element generated for the first condition, the rest will get the file associated with the second condition.

The syntax may also dictate that the located mapping line may result in mapper 340 further interpreting the supplied cookie or other HTTP header as list of values and instructing the page assembler 340 to assemble the personalized content elements corresponding to each list element.

Once the mapper 340 has found the correct personalized content element on the web server file system, it hands it back to the web server process to complete the evaluation of the user request.

The mapper 340 may be requested to evaluate one or more of the content elements in the web page. The mapper 340 can be used as many times as the web page requires to find the correct selection of mapped content elements. The mapper 340 can also decide on the choice of content elements based on 1: multiple cookie values (weather, news selection, name), 2: IP address, 3: browser type or user agent, 4: any other HTTP header value. The mapper 340 can also use any combination of these “variables”. The mapper 340 can also just take the signature URL with no specific “uniqueness” and take that content element from the web server file system.

If the mapper 340 determines that the signature URL does not exist or has been specified to not be on the web server file system, the mapper 340 may tell the web server 310 to communicate with the application server 320 to generate that content element/file, as in normal conditions. If the mapper 340 determines that the signature URL does exist but the file is not on the web server file system, it will communicate with the publisher 370 to generate and send the web server 310 the appropriate content element/file.

As further explained below, the application server 320 sends content elements to be prestored on the web server 310. This condition may be used in conjunction with a web page or content element that is not already on the web server file system and has been identified in the mapping file to be pulled from the web server file system. Normally, the publisher 370 has a complete set of content elements to pre-generate and send to the web server file system.

In the event that the user web page request includes a request for one or more content elements that have not been prestored on the web server 310, the web server 310 may send a request to the application server 320 for the requested content element. For example, a particular ISP may decide to prestore stock quotes for 500 different commonly held stocks. If a user requests a quote for a different stock on the user's request, the web server 310 may send a request for a content element to the application server 320, where it may be obtained and sent back to the web server 310. This new content element may now be stored in the web server, so that if it is again requested, it is available on the web server file system. The web page request may thus include a plurality of requested content elements, some of which may be prestored on the web server 310, and some of which may not be prestored. The web server then obtains the requested content elements that were not prestored from the application server 320, after which they may be stored on the web server 310.

The application server 320 is generally not used based on a user request for one or more web pages. The application server 320 may include a publisher 370, which may be programmed to send content elements to the web server 310, to be stored as content elements 360. The content elements may be prestored in the web server 310, using the signature URLs as file names, so that web pages may be dynamically assembled in the web server 310 without the need to send a request to the application server 320. For example, an ISP may have personalized web pages that it may make available to its customers. The web pages may include a plurality of content elements that the user may select from to create a personalized page. These content elements may include things like weather for a particular area or areas, stock quotes for particular stocks, news stories from a particular source or sources, or any other information that may be available and/or desired. By prestoring the content elements on the web server 310, there is no need to send a request to the application server 320 to assemble the personalized page. This reduces the need for the usually scarce application server resources, and greatly speeds the time to create and deliver the personalized page to the user.

The publisher 370 may be a program to send updated content elements to the web server 310. For example, the publisher may send updated content elements at predetermined time intervals, such as every fifteen minutes, or any other desired time interval. The publisher 370 may also send updated or new content elements to the web server 310 when a new item is received from a particular source. For example, when a revised stock quote is received at the application server, the publisher 370 may be programmed to send the updated content element to the web server 310, where it may be stored in place of the corresponding, previous content element. In this way, updated web pages may be assembled by the web server 310, again without the need to consult the application server 320 after receipt of a web page request from a user.

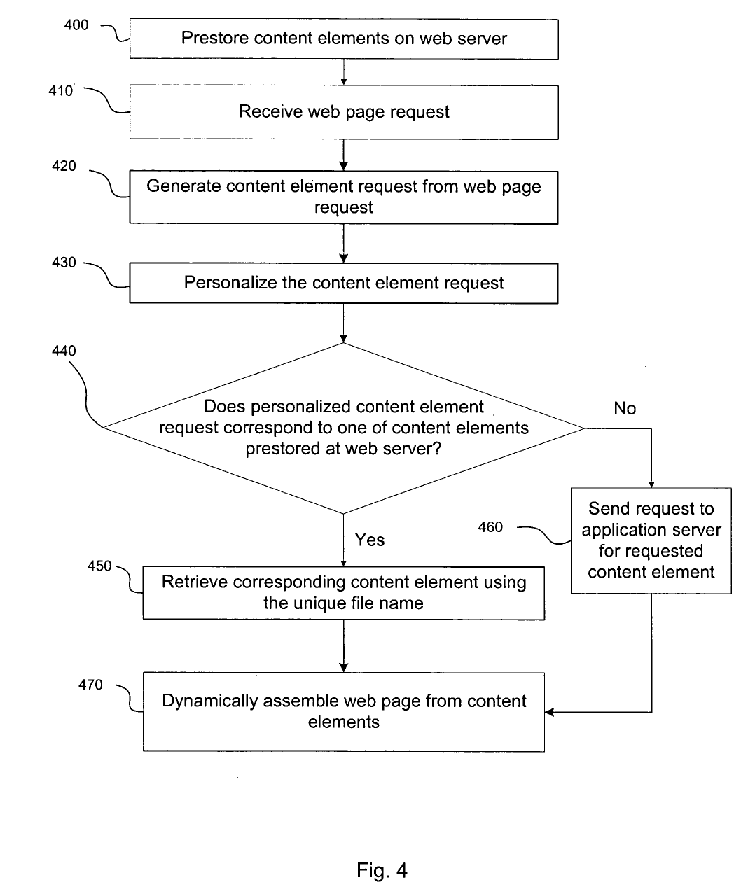

FIG. 4 illustrates a flowchart in accordance with embodiments of the present invention. In step 400, one or more content elements are prestored at the web server using a unique file name, as described above.

In step 410, a web page request is received from a user, typically from a user's browser. In step 420, the web server generates a content element request from the web page request, as described above. In step 430, the content element request is personalized.

In step 440, it is determined whether the personalized content element request corresponds to one of the content elements prestored at the web server. If the personalized content element request corresponds to a content element prestored at the web server, then in step 450, the corresponding content element is retrieved using the unique file name. If the personalized content element request does not correspond to a content element prestored at the web server, in step 460 a request is sent to an application server for a content element corresponding to the personalized content element request. In step 470, the web page is dynamically assembled from the content element or elements.

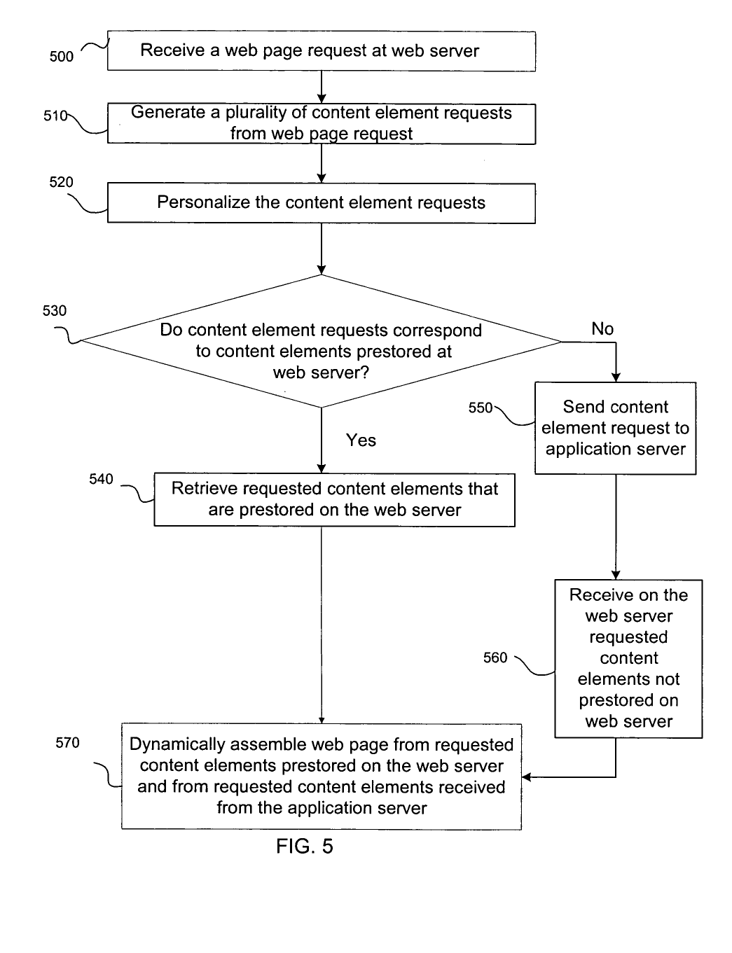

FIG. 5 illustrates a flow chart in accordance with embodiments of the present invention. In step 500 a web page request is received at a web server.

In step 510, the web server generates a plurality of content element requests from the web page request. In step 520, the content element requests are personalized, as described above.

In step 530, the web server determines whether the content element requests correspond to content elements prestored at the web server. If the content element requests correspond to content elements prestored at the web server, then the requested content elements are retrieved in step 540. If the requested content elements are not prestored at the web server, then in step 550 another content element request is sent to an application server, and in step 560 the requested content elements not prestored on the web server are received.

In step 570, the web page is dynamically assembled from the requested content elements prestored on the web server, and from any requested content elements received from the application server.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method of dynamically assembling a web page at a web server, comprising:
prestoring a plurality of content elements on the web server by associating each of the content elements with a unique file name;
receiving a web page request at the web server;
generating a content element request from the web page request;
personalizing the content element request;
determining whether the personalized content element request corresponds to one of the plurality of content elements prestored at the web server;
retrieving the corresponding content element using the unique file name; and
dynamically assembling the web page from the corresponding content element.

2. The method of claim 1, further comprising, if the personalized content element does not correspond to one of the plurality of content elements prestored at the web server, sending a request to an application server for the personalized content element.

3. The method of claim 2, further comprising receiving the personalized content element from the application server and storing the personalized content element on the web server.

4. The method of claim 3, further comprising generating a plurality of content element requests from the web page request, a first one of the content elements being prestored on the web server, and a second one of the content element elements not being prestored on the web server, further comprising sending a request to an application server for the second one of the content elements.

5. The method of claim 1, wherein prestoring a plurality of content elements on the web server comprises prestoring the plurality of content elements in a web server file system.

6. The method of claim 1, wherein the step of prestoring a plurality of content elements on the web server comprises prestoring selected ones of the plurality of content elements at predetermined time intervals.

7. The method of claim 6, wherein the predetermined time intervals are different for different ones of the plurality of content elements.

8. The method of claim 4, further comprising updating the content elements at the application server, and wherein the step of prestoring the plurality of content element at the web server comprises automatically sending an updated content element from the application server to the web server, and storing the updated content element as one of the plurality of content elements.

9. A method of assembling a dynamic web page at a web server, comprising:
receiving a web page request at the web server;
generating a plurality of content element requests from the web page request;
personalizing the plurality of content element requests;
determining whether the content element requests correspond to one of a plurality of content elements prestored on the web server;
retrieving the corresponding content elements;
sending another content element request to an application server for any of the content element requests that do not have corresponding content elements prestored on the web server;
receiving at the web server another content element corresponding to the another content element request, from the application server; and
dynamically assembling the web page from the corresponding content elements prestored on the web server and from another content element received from the application server.

10. The method of claim 9, further comprising storing the another content element on the web server.

11. The method of claim 9, further comprising updating and storing the another content element at the web server from a content element on the application server.

12. The method of claim 9, wherein the content elements are updated and stored at predetermined time intervals.

13. The method of claim 9, wherein the requested content elements prestored at the web server are prestored in a web server file system.

14. A system to dynamically assemble a web page, comprising a web server that prestores a plurality of content elements by associating each of the content elements with a unique file name, receives a web page request, generates a content element request from the web page request, personalizes the content element request, determines whether the personalized content element request corresponds to one of the plurality of content elements prestored at the web server, retrieves the corresponding content element using the unique file name, and dynamically assembles the web page from the corresponding content element.

15. The system of claim 14, wherein the web server sends a request to an application server for the corresponding content element if the corresponding content element is not prestored on the web server.

16. The system of claim 15, wherein the web server receives the requested content element from the application server and stores the requested content element.

17. The system of claim 15, wherein the web server generates a plurality of content elements requests, a first one of the content element requests corresponds to a content element prestored on the web server, and a second one of the content element requests does not correspond to a content element prestored on the web server, wherein the web server sends a request to an application server for the second one of the content elements.

18. The system of claim 15, wherein the web server prestores the plurality of content elements in a web server file system.

19. The system of claim 15, wherein the web server prestores selected ones plurality of content elements at predetermined time intervals.

20. The system of claim 19, wherein the predetermined time intervals are different for different ones of the plurality of content elements.

21. A system to assemble a dynamic web page, comprising:
a web server that receives a web page request, generates a plurality of content element requests from the web page request, personalizes the plurality of content element requests, determines whether the content element requests correspond to one of a plurality of content elements prestored on the web server, and retrieves the corresponding content elements; and
an application server that receives another content element request from the web server for any of the content element requests that do not have corresponding content elements prestored on the web server, and sends the another content elements to the web server, wherein
the web server dynamically assembles the web page from the corresponding content elements prestored on the web server and from another content element received from the application server.

22. The system of claim 21, wherein the web server stores the another content element sent from the application server.

23. The system of claim 21, wherein the application server updates and the another content element.

24. The system of claim 21, wherein the another content element is updated and stored at predetermined time intervals.

25. The system of claim 21, wherein the plurality of content elements prestored at the web server are prestored in a web server file system.

26. A machine-readable medium having stored thereon a plurality of executable instructions, the plurality of instructions comprising instructions to:
pre-store a plurality of content elements on the web server by associating each of the content elements with a unique file name;
receive a web page request at the web server;
generate a content element request from the web page request;
personalize the content element request;
determine whether the personalized content element request corresponds to one of the plurality of content elements prestored at the web server;
retrieve the corresponding content element using the unique file name; and
dynamically assemble the web page from the corresponding content element.

27. A machine-readable medium having stored thereon a plurality of executable instructions, the plurality of instructions comprising instructions to:
receive a web page request at the web server;
generate a plurality of content element requests from the web page request;
personalize the plurality of content element requests;
determine whether the content element requests correspond to one of a plurality of content elements prestored on the web server;
retrieve the corresponding content elements;
send another content element request to an application server for any of the content element requests that do not have corresponding content elements prestored on the web server;
receive at the web server another content element corresponding to the another content element request, from the application server; and
dynamically assemble the web page from the corresponding content elements prestored on the web server and from another content element received from the application server.
